(19) United States
(12) Patent Application Publication
(10) Pub. No.: US 2018/0210997 A1
(43) Pub. Date: Jul. 26, 2018

(54) OBJECT TRACKING FOR DESIGN IMAGE PROJECTION

(71) Applicant: Wieden + Kennedy, Inc., Portland, OR (US)

(72) Inventors: Nilesh Ashra, Portland, OR (US); Rafael Kfouri de Vilhena Nunes, Portland, OR (US); David Glivar, Portland, OR (US); Keith Eric Hamilton, West Linn, OR (US); Zhao He, Portland, OR (US); Michael Alexander Latzoni, Beaverton, OR (US); Paulo Joao Ribeiro, Portland, OR (US); Tera Hatfield, Portland, OR (US); Ryan Kee, Portland, OR (US)

(21) Appl. No.: 15/880,233

(22) Filed: Jan. 25, 2018

Related U.S. Application Data
(60) Provisional application No. 62/450,906, filed on Jan. 26, 2017.

(51) Int. Cl. G06F 17/50; G01B 11/24; G03B 21/00

(52) U.S. Cl. CPC G06F 17/5086; G03B 21/00; G01B 11/24

(57) ABSTRACT

A light sensor may capture a first pattern of nonvisible light reflected from reflective components on a surface of an article. A computing device may generate, based on the first pattern of nonvisible light and an article design selected by a user, a first design image. An image projector may project the first design image at a target area containing at least part of the article.

### BACKGROUND

Customers often wish to consider the appearance of a variety of designs when deciding to purchase wearable articles. For example, a customer may be in the market for a particular shoe and wish to try on the shoe in a variety of colors and textures. Retail outlets often maintain a quantity of merchandise disproportionate to the quantity of merchandise likely to ultimately be sold for the purposes of allowing shoppers to try different designs and sizes of wearable articles. This excess merchandise creates several disadvantages including costs in shipping, storage, and maintenance.

### BRIEF SUMMARY

According to embodiments of the disclosed subject matter, a light sensor may capture a first pattern of nonvisible light reflected from reflective components on a surface of an article. A computing device may generate, based on the first pattern of nonvisible light and an article design selected by a user, a first design image. An image projector may project the first design image at a target area containing at least part of the article.

An apparatus may include a floor having a target area, nonvisible light sensors attached to columns that extend up at areas of the floor outside of the target area, image projectors, outside of the target area and in communication with the nonvisible light sensors, and mirrors attached to support structures that extend up at areas of the floor outside of the target area, and have reflective surfaces that reflect at the target area a beam output from an image projector.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosure, are incorporated in and constitute a part of this specification. The drawings also illustrate implementations and embodiments of the disclosure and together with the detailed description serve to explain the principles of implementations and embodiments of the disclosure. No attempt is made to show structural details in more detail than may be necessary for a fundamental understanding of the disclosure and various ways in which it may be practiced.

FIG. 1 shows an example of a structure for design image projection according to an embodiment of the disclosure.

FIG. 2 shows an example article for receiving a projected design image according to an embodiment of the disclosure.

FIG. 3 shows an example procedure for generating and projecting a design image at an article according to an implementation of the disclosure.

FIG. 4 shows an example procedure for generating and projecting a design image at an article in motion according to an implementation of the disclosure.

FIG. 5 shows, according to an embodiment of the disclosure, an example computing device suitable for implementations of the disclosure.

FIG. 6 shows, according to an embodiment of the disclosure, an example network arrangement suitable for implementations of the disclosure.

### DETAILED DESCRIPTION

Embodiments of the disclosure may include a system for tracking a wearable article within a target area of a structure and projecting an article design selected by a user onto the wearable article. For example, a user may select, using the user's mobile device, an article design for a wearable article, such as a pattern, texture, or color scheme for a shoe. The mobile device may transmit the selected article design to a computing device in communication with one or more image projectors. The user may wear generically colored versions of the shoe. A set of reflective components may be attached to the shoes' surface. The user may then walk into the target area of the structure. A set of infrared light sensors or other type of sensors may track the shoes in the target area and may provide the position of the reflective components attached to the shoes to the computing device in communication with the image projectors. The computing device may generate a design image of the selected article design to project into the target area based on the received positions of the reflective components on the shoes. The projection thrown into the target area may project the design image onto the shoes and substantially fill the remaining area of the target area with white light. The user may walk throughout the target area and the system may receive updated positions and generate updated design images that maintain the projection of the article design on the shoes as the user walks.

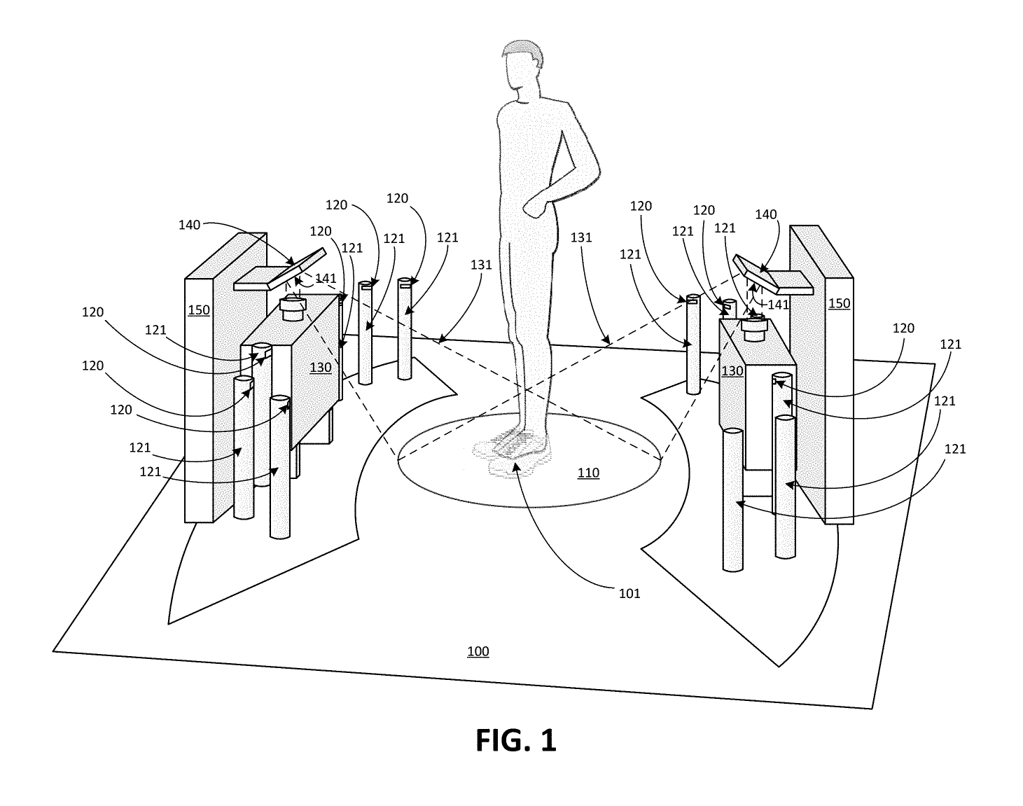

The system of this disclosure may include a variety of components, including a structure for design image projection. FIG. 1 shows an example of a structure for design image projection according to an embodiment of the disclosure. The structure may include a floor 100 having a target area 110. The target area 110 may be visually identifiable such as a region of the floor 100 that is outlined, manufactured of a different material, or having different coloration than other areas of the floor 100. The target area 110 may also be a region of the floor 100 without identifying markings. For example, the target area 110 may be the region of floor 100 defined by the area of the image thrown by projectors 130. In some embodiments, the structure may not include a target area. For example, in some embodiments projectors 130 may track the motion of article 101, and the projectors 130 may adjust their positon to output their projections to different locations as the article 101 changes position.

The structure may include a set of one or more sensors 120 that collect data about article 101. For example, the sensors 120 may be nonvisible light sensors that detect electromagnetic radiation in wavelengths other than from about 390 nanometers (nm) to about 700 nm. In some embodiments sensors 120 may be infrared cameras that detect electromagnetic radiation in wavelengths from about 700 nanometers (nm) to about 1000000 nm. In some embodiments, the sensors 120 may be visible light sensors that detect electromagnetic radiation in wavelengths from about 390 nm to about 700 nm. In some embodiments, sensors 120 may be acoustic sensors that detect acoustic waves from outside or within the range of human hearing. For example, sensors 120 may be acoustic sensors that detect ultrasonic frequency sound, which may be sound waves at frequencies greater than about 20,000 Hertz (Hz) and/or infrasonic frequency sound, which may be sound waves at frequencies less than about 20 Hz. Sensors 120 may include emission components that output electromagnetic radiation and capture the radiation's reflection from articles in the radiation's beam path. For example, sensors 120 may be active infrared sensors that include light emitters that emit infrared radiation. In some embodiments, sensors 120 may include acoustic emitters that emit acoustic waves in audible or nonaudible frequencies, such as ultrasonic or infrasonic frequencies.

Sensors 120 may be attached to or integrated with support structures such as columns 121 that extend up at various areas of the floor 100. For example, columns 121 may extend upwards at areas of floor 100 that are outside of the target area 110. In general, sensors 120 may be positioned with respect to article 101 and/or target area 110 in any manner suitable for the purposes of this disclosure. Although FIG. 1 shows twelve sensors 120 and twelve columns 121, any number of sensors and any number of support structures that are suitable for the purposes of this disclosure are contemplated herein.

Structures for projecting an article design may include a set of one or more image projectors 130 in communication with sensors 120. Image projectors 130 may include any device suitable for projecting an image or a moving image onto a surface. Image projectors 130 may include, for example, laser diode projectors, hybrid light emitting diode projectors, light emitting diode projectors, liquid crystal on silicon projectors, digital light processing projectors, liquid crystal display projectors, or cathode ray tube projectors. In general, image projectors 130 may be positioned outside of target area 100 using support structures; however, image projectors 130 may be positioned with respect to article 101 and/or target area 110 in any manner suitable for the purposes of this disclosure. Although FIG. 1 shows two image projectors 130, any number of image projectors suitable for the purposes of this disclosure are contemplated herein. Image projectors 130 may be in communication with sensors 120 via hardwire connections and/or wireless connections, including wireless local area networks, such as Wifi, ZigBee, Bluetooth, or any other suitable network connection such as those discussed with respect to FIG. 6 below.

In some embodiments, a set of one or more mirrors 140 may be arranged within the beam path of image projectors 130. For example, image projectors 130 may be arranged to throw their projections away from the position of article 101. Mirrors 140 may be attached to a set of one or more support structures 150 that extend up at areas of the floor outside of the target area 110. Reflective surfaces 141 of mirrors 140 may intersect the beams output from image projectors 130. Mirrors 140 may be angled so that reflective surface 141 reflects the beams output from image projectors 130 at the target area 110 of floor 100. In other embodiments, image projectors 130 may project design images directly at target area 110 or article 101 without mirrors 140. Although FIG. 1 shows two mirrors 140, this disclosure contemplates any number of mirrors and mirror arrangements suitable for the purposes of this disclosure, including adjustable mirrors that may be repositioned to reflect beams output by projectors 130 at article 101 as it moves around floor 100.

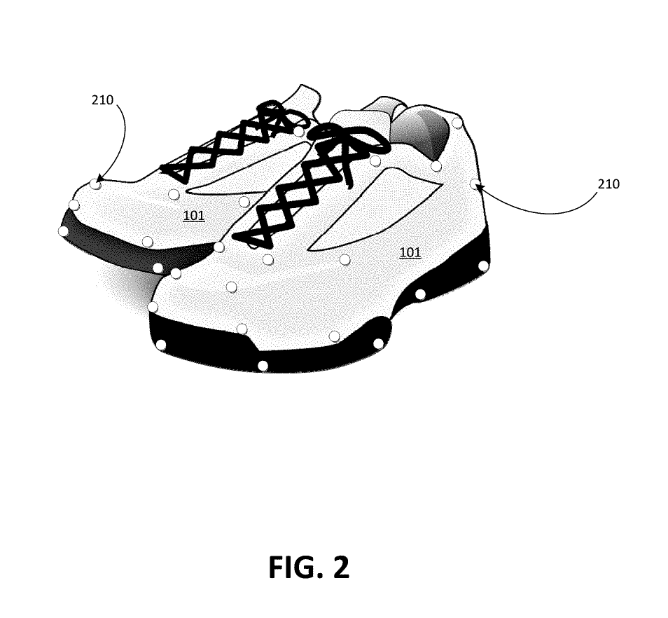

FIG. 2 shows an example article for receiving a projected design according to an embodiment of the disclosure. In FIGS. 1 and 2, article 101 is depicted as footwear. Other types of articles are also contemplated by this disclosure. For example, articles may include wearable articles such as armwear, belts, coats, dresses, gowns, headgear, hosiery, jackets, jeans, neckwear, suits, outerwear, robes, cloaks, shawls, wraps, skirts, sportswear, swimwear, trousers, shorts, undergarments, watches, jewelry and wedding clothing. In some embodiments, design images may be projected on articles other than wearable articles. For example, articles may include handbags, wallets, luggage, sheets, bedding, kitchenware, pottery, glassware, furniture, or any other items upon which a design image may be projected.

Article 101 may have any surface coloration and materials that are receptive to the projection of design images. For example, article 101 may include a low gloss surface coated with a white or near white or silver pigment or similar neutral or metalized color. In some implementations, the coloration of a design image to be projected onto article 101 may be adjusted based on the coloration and textures of article 101. For example, the design image may be adjusted so that the projected design image may display an accurate representation of the article 101 as if it were manufactured of materials having the coloration and texture of the article design selected by the user.

Article 101 may have a set of one or more reflective components 210 disposed over the surface of article 101. Reflective components 210 may reflect visible light and nonvisible light such as infrared radiation. Reflective components 210 may also reflect acoustic waves such as ultrasonic frequency waves or infrasonic frequency waves. Reflective components may also be active emitters such that they generate electromagnetic radiation or acoustic waves in addition to or instead of reflecting electromagnetic radiation and acoustic waves. Reflective components 210 may be removably positioned on article 101 at locations that may indicate the contours, vertices, and/or related structural features of article 101. In some embodiments, aspects of the radiation or acoustic wave reflected or emitted by a particular reflective component may uniquely identify the particular reflective component within data from radiation or acoustic waves captured by sensors 120. For example, a particular reflective component may actively emit radiation or selectively reflect radiation at a particular frequency, such as through manipulating reflective characteristics of the surface of the particular reflective component or activating an infrared emitter at a particular frequency.

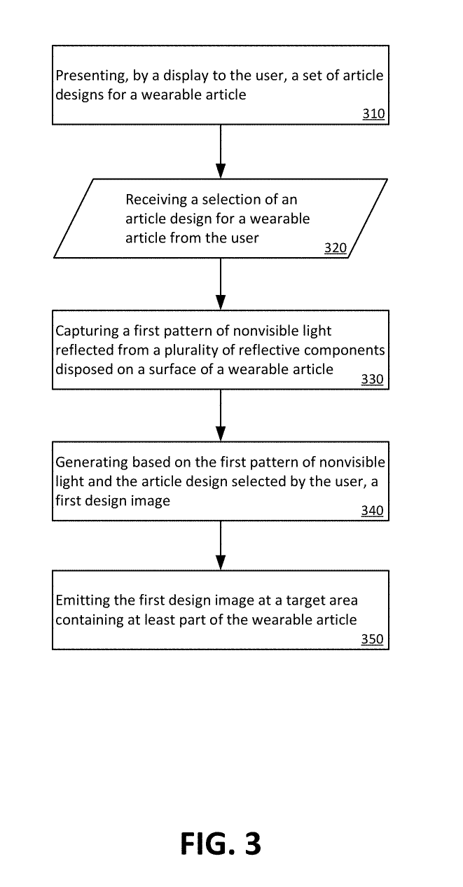

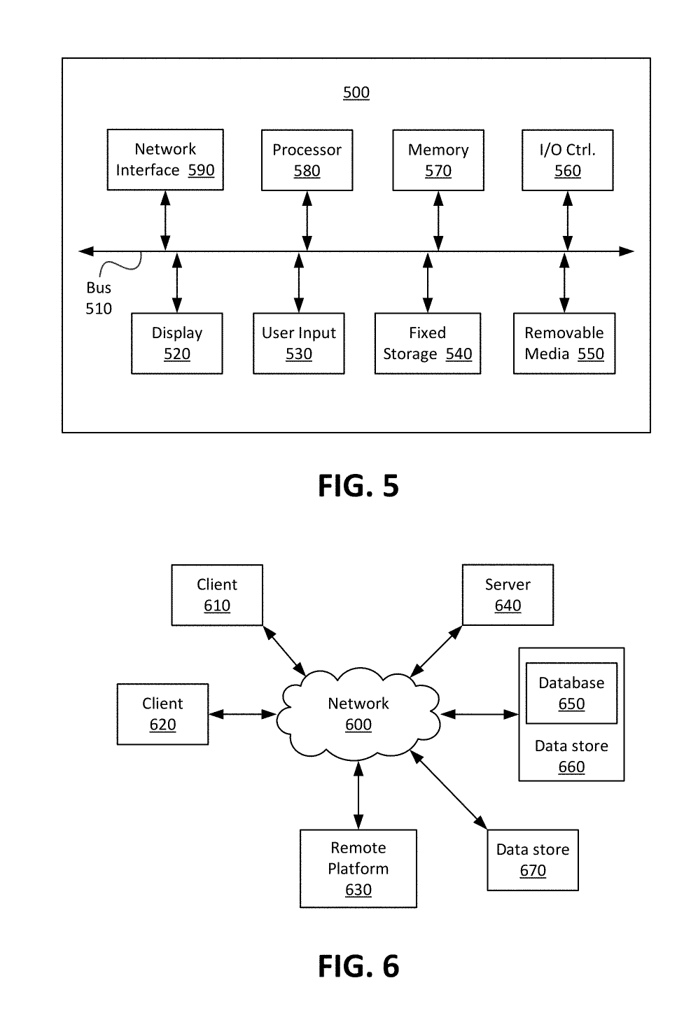

The system of this disclosure may execute various procedures for projecting design images on to an article. FIG. 3 shows an example procedure for generating and projecting a design image at an article according to an implementation of the disclosure. A user may engage an interface presented via a computing device, such as a tablet or any other computing device suitable for the purposes of this disclosure, such as those described with respect to FIGS. 5 and 6 below. The interface may display a set of one or more article designs for article 101. For example, article 101 may be a wearable article such as a shoe. The interface may present twelve different article designs for the shoe from which the user may choose. For example, one of the article designs may show a shoe having a low gloss grey leather upper with bright yellow suede design elements, white glossy accents, a black rubber sole, and so forth. The user may select a particular article design by manipulating the interface of the tablet. The tablet may transmit the selected article design to a computing device in communication with image projectors 130, and the computing device may receive the selection of the article design at 320. In some implementations, the tablet may receive the user's selection and directly execute the procedure described in FIG. 3 without communicating the user selection to a separate computing device. In other implementations, a user may create a new design for article 101 by manipulating the tablet interface to select particular colors, textures, patterns, and so forth and apply them to selected areas of article 101. The user may also select a particular model of article 101 and a size via the interface.

A computing device in communication with image projectors 130 may receive the article design selection along with the particular size and model of article 101. The user may then wear article 101 and walk into the target area 110. At 330 sensors 120 may capture a first pattern of nonvisible light reflected from a plurality of reflective components 210 located on the surface of article 101. Sensors 120 may transmit data representing the first pattern of nonvisible light to the computing device in communication with image projectors 130. Based on the first pattern of nonvisible light and the article design selected by the user, the computing device may generate a first design image to be projected at the target area 110 at 340. At 350 projectors 130 may output the first design image at the target area 110 while it contains at least part of article 101.

The computing device may generate the first design image utilizing a variety of techniques in accordance with implementations of this disclosure. For example, reflective components 210 may be positioned on article 101 in predetermined locations. Indicators of the model and size of article 101 may be received by the computing device when the user selects the article design. The predetermined locations of the reflective components 210 on article 101 may be stored as dimension characteristics for the particular model and size of the article in a data store accessible by the computing device, such as any of those discussed with respect to FIGS. 5 and 6 below. Dimension characteristics may include, for example, the relative distances between reflective components, three dimensional models of the article including positions of the reflective components, coordinates of the reflective components over the surface of the article, versions of the three dimensional models with different article designs applied, or any other dimension characteristic suitable for the purposes of the disclosure, any of which may be stored and associated with the model, size, and/or other dimension characteristics of article 101.

The position of article 101 within target area 110 may be determined utilizing a variety of techniques according to implementations of this disclosure. For example, dimension characteristics of article 101 may include positional data including known distances between two particular reflective components 210, a distance from article 101 to one or more sensors 120 when a calibration image of article 101 is captured by one or more sensors 120, and an apparent distance and orientation between the two reflective components within the captured calibration image. The dimension characteristics may be stored in a data store in communication with projectors 130 and used as a basis for later position determinations of article 101 within target area 101. For example, utilizing triangle similarity techniques and these dimension characteristics, additional images of article 101 captured by sensors 120 may be processed to determine the distance of the article 101 from the sensors 120 based on differences in the apparent distances and orientation between the two particular reflective components 120. These distances along with known positions of sensors 120 and target area 110 over floor 100 may be used as a basis for determining the position of article 101 in target area 110.

Additional techniques for determining the position of article 101 are also contemplated by this disclosure. For example, one or more sensors 120 may be an active infrared sensor that emits and captures infrared radiation. Sensors 120 may emit a predetermined pattern of structured beams of infrared radiation, such as scans using one or more infrared lasers. Fixed or programmable structured light techniques may be employed to detect variations in the patterns of radiation once it is reflected, such as the dimensional spreading, geometrical skewing, or depth of infrared elements in order to determine position information of article 101. In another example, stereo techniques may be employed to detect a variation between the location of an aspect of a pattern of radiation captured in a first sensor 120 and the location of the same aspect in a second sensor 120. This variation may be used to determine the distance of article 101 from the respective sensors 120. As another example, time-of-flight techniques may be utilized to measure the time between a pulse of a beam of radiation emitted from a sensor 120 and the captured reflection of the emitted pulse. The time of flight may then be used to determine the distance to article 101 from the respective sensor 120.

The patterns of reflected radiation, such as nonvisible light, that are captured by sensors 120 may be compared to the dimension characteristics of article 101. Based on a result of this comparison, a three-dimensional model of the shoe may be generated. The version of the three-dimensional model having the selected article design may then be accessed from the data store and adjusted (for example, scaled or otherwise transformed) based on the indicated size of article 101. In some implantations, the selected article design may be filled over all or part of the surface of the generated three-dimensional model by the computing device rather than accessed as a pre-generated version from the data store.

The image projection system may determine the location of the three-dimensional model of the selected article design within target area 110 based, for example, on predetermined locations of sensors 120 with respect to the target area and the calculated distance from sensors 120 to article 101 as discussed above. Thus, with the orientation and position of article 101 determined, the computing device may render a two-dimensional image of the selected article design disposed over the surface of the three-dimensional model of article 101 within target area 110. This two-dimensional image may then be output by projectors 130 at target area 110 as the design image. The emission of the design image may include projecting the image of the selected article design onto the surface of article 101 and projecting an image of empty space onto surfaces within the target area other than the surfaces of article 101. For example, projectors 130 may output white light onto surfaces within the target area other than the surfaces of article 101. White light may be light that appears colorless or to be empty space, such as light that includes substantially all the wavelengths of the visible spectrum at substantially equal intensity. Projectors 130 may also output other imagery onto surfaces within the target area other than the surfaces of article 101. For example, other imagery may include patterns, neutrally colored light, or any other type of projectable imagery suitable for purposes of this disclosure.

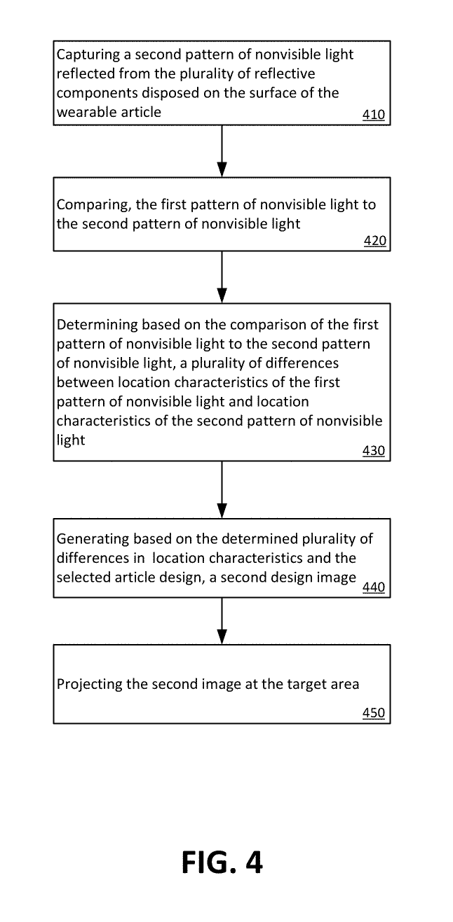

A user may wish to see how the selected design looks on article 101 as the user walks through target area 110. The image projection system may track article 101 as it moves and update the location of the projected design image over time. FIG. 4 shows an example procedure for generating and projecting a design image at an article in motion according to an implementation of the disclosure. At 410 sensors 120 may capture a second pattern of nonvisible light reflected from the reflective components 210 disposed on the surface of article 101. A 420 the second pattern of nonvisible light may be compared to the first pattern of nonvisible light captured at an earlier time, and at 430 a set of one or more differences may be determined between location characteristics of the first pattern of nonvisible light and location characteristics of the second pattern of nonvisible light.

The set of differences in location characteristics in the first and second patterns of nonvisible light may be measured to update the projected design image. For example, the same reflective component may be identified in the first pattern of reflected nonvisible light and the second pattern of reflected nonvisible light based on the reflective component's position relative to other reflective components or based on an identifier included in the light reflected or emitted by the reflective component. Each reflective component may have its own signature that may be recognized by the system. The change in position of the reflective component may be determined by comparing its position in the first and second patterns of radiation and a motion vector may be generated for the component that represents the change in position. The three-dimensional model of article 101 having the selected article design may be repositioned, rotated, or tilted base on this and other motion vectors that are determined for reflective components in a similar manner. Thus at 440, a second two-dimensional design image of article 101 in target area 110 may be generated by the computing device based on the set of differences in location characteristics and the selected article design. The second design image may be projected at target area 110 by projectors 130 at 450. This procedure may repeat as article 101 moves throughout target area 110.

In other implementations, the change in position in of article 101 may be determined by calculating the position and orientation of article 101 within target area 110 based on the second pattern of nonvisible light in the same manner as the initial position and orientation were calculated based on the first pattern as described above.

In any of the implementations or embodiments of this disclosure, the emitted or reflected light may include any form of electromagnetic radiation, both visible and nonvisible. Any of the procedures disclosed herein, including those for executing the user design selection interface, may be implemented on one or more computing devices directly connected to image projectors 130 or remotely connected such as via a network such as the Internet, or any other suitable network connection, such as that described below with respect to FIGS. 5 and 6.

Implementations of the disclosure may be implemented in and used with a variety of component and network architectures. FIG. 5 is an example computing device 500, suitable for implementations of the disclosure. Computing devices, such as computing device 500, may include computers, servers, mainframes, desktops, laptops, tablets, smart phones, wearable devices, and other computing devices. The computing device 500 includes a bus 510 which interconnects major components of the computing device 500, such as a central processor 580, a memory 570 (typically RAM, but which may also include ROM, flash RAM, or the like), an input/output controller 560, a user display 520, such as a display screen via a display adapter, a user input interface 530, which may include one or more controllers and associated user input devices such as a keyboard, mouse, and the like, and may be closely coupled to the I/O controller 560, fixed storage 540, such as a hard drive, flash storage, Fibre Channel network, SAN device, SCSI device, and the like, and a removable media component 550 operative to control and receive an optical disk, flash drive, and the like.

The bus 510 allows data communication between the central processor 580 and the memory 570, which may include read-only memory (ROM) or flash memory (neither shown), and random access memory (RAM) (not shown), as previously noted. The RAM is generally the main memory into which the operating system and application programs are loaded. The ROM or flash memory may contain, among other code, the Basic Input-Output system (BIOS) which controls basic hardware operation such as the interaction with peripheral components. Applications resident with the computing device 500 are generally stored on and accessed via a computer-readable medium, such as a hard disk drive (e.g., fixed storage 540), an optical drive, floppy disk, or other storage medium.

The fixed storage 540 may be integral with the computing device 500 or may be separate and accessed through other interfaces. A network interface 590 may provide a direct connection to a remote server via a telephone link, to the Internet via an interne service provider (ISP), or a direct connection to a remote server via a direct network link to the Internet via a POP (point of presence) or other technique. The network interface 590 may provide such connection using wireless techniques, including digital cellular telephone connection, Cellular Digital Packet Data (CDPD) connection, digital satellite data connection or the like. For example, the network interface 590 may allow the computing device to communicate with other computing devices via one or more local, wide-area, or other networks, as shown in FIG. 6.

Many other devices or components (not shown) may be connected in a similar manner (e.g., document scanners, digital cameras and so on). Conversely, all of the components shown in FIG. 5 need not be present to practice the present disclosure. The components may be interconnected in different ways from that shown. The operation of a computing device such as that shown in FIG. 5 is readily known in the art and is not discussed in detail in this application. Code or instructions to implement this disclosure may be stored in computer-readable storage media such as one or more of the memory 570, fixed storage 540, removable media 550, or on a remote storage location.

FIG. 6 shows an example network arrangement according to an implementation of the disclosure. One or more clients 610, 620, such as local computing devices, smart phones, tablet computing devices, and the like may connect to other devices via one or more networks 600. The network may be a local network, wide-area network, the Internet, or any other suitable communication network or networks, and may be implemented on any suitable platform including wired and/or wireless networks. The clients may communicate with one or more servers 640 and/or databases 650. The devices may be directly accessible by the clients 610, 620, or one or more other devices may provide intermediary access such as where a server 640 provides access to resources stored in a database 650. Database 650 may be implemented on a data store 660, whereas data store 670 may store data in a non-database format. A data store may be any suitable combination of hardware and software for storing structured and/or unstructured data. The clients 610, 620 also may access remote platforms 630 or services provided by remote platforms 630 such as cloud computing arrangements and services. The remote platform 630 may include one or more servers and/or databases.

More generally, various implementations of this disclosure may include or be implemented in the form of computer-implemented procedures or processes and apparatuses for practicing those processes. Implementations also may be implemented in the form of a computing device program product having instructions or computer program code containing instructions implemented in non-transitory and/or tangible media, such as floppy diskettes, CD-ROMs, hard drives, USB (universal serial bus) drives, or any other machine readable storage medium, wherein, when the computing device program code is loaded into and executed by a computing device, the computing device becomes an apparatus for practicing implementations of the disclosure.

Implementations also may be implemented in the form of computer program code, for example, whether stored in a storage medium, loaded into and/or executed by a computing device, or transmitted over some transmission medium, such as over electrical wiring or cabling, through fiber optics, or via electromagnetic radiation, wherein when the computer program code is loaded into and executed by a computing device, the computing device becomes an apparatus for practicing implementations of the disclosure. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosure in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosure.

The foregoing description, for purpose of explanation, has been described with reference to specific implementations. However, the illustrative discussions above are not intended to be exhaustive or to limit implementations of the disclosure to the precise forms disclosed. Many modifications and variations are possible in view of the above teachings. The implementations were chosen and described in order to explain the principles of implementations of the disclosure and their practical applications, to thereby enable others skilled in the art to utilize those implementations as well as various implementations with various modifications as may be suited to the particular use contemplated.

1. A method comprising:
capturing, by a light sensor, a first pattern of nonvisible light reflected from a plurality of reflective components disposed on a surface of an article;
generating, by a computing device, based on the first pattern of nonvisible light and an article design selected by a user, a first design image; and
projecting, by an image projector, the first design image at a target area containing at least part of the article.

2. The method of claim 1, wherein the emission of the first design image at the target area comprises projecting an image of the selected article design onto a surface of the article.

3. The method of claim 1, wherein the emission of the first design image at the target area comprises:
projecting an image of the selected article design onto a surface of the article; and
projecting an image of empty space onto surfaces in the target area other those of the article.

4. The method of claim 1, wherein the generation of the first design image is further based on a dimension characteristic of the article.

5. The method of claim 1, wherein the generation of the first design image comprises:
generating a three-dimensional model of the article based on the first pattern of nonvisible light and a dimension characteristic of the article; and
generating a two-dimensional image of the selected article design disposed over a surface of the three-dimensional model of the article.

6. The method of claim 1, further comprising:
presenting, by a display to the user, a plurality of article designs comprising the selected article design.

7. The method of claim 1, further comprising:
capturing, by the light sensor, a second pattern of nonvisible light reflected from the plurality of reflective components disposed on the surface of the article;
comparing, by the computing device, the first pattern of nonvisible light to the second pattern of nonvisible light;
determining, by the computing device, based on the comparison of the first pattern of nonvisible light to the second pattern of nonvisible light, a plurality of differences between location characteristics of the first pattern of nonvisible light and location characteristics of the second pattern of nonvisible light;
generating, by the computing device, based on the determined plurality of differences in location characteristics and the selected article design, a second design image; and
projecting, by the image projector, the second design image at the target area.

8. The method of claim 1, wherein the projection of the first design image comprises projecting, by the image projector, the first design image at a reflective surface of a mirror that reflects the first design image at the target area.

9. The method of claim 1, wherein the first pattern of nonvisible light comprises light in a range of wavelengths other than from about 390 nanometers (nm) to about 700 nm.

10. The method of claim 1, wherein:
the first pattern of nonvisible light comprises light in a range of wavelengths other than from about 390 nm to about 700 nm; and
the first design image comprises light in a range of wavelengths between about 390 nm and about 700 nm.

11. The method of claim 1, further comprising emitting, from an emission component, nonvisible light at the plurality of reflective components disposed on the surface of the article.

12. A system comprising:
a floor having a target area;
a light sensor;
an image projector;
a processor in communication with the light sensor and the image projector, and
a non-transitory, computer readable medium in communication with the processor and storing instructions that, when executed by the processor, cause the processor to perform operations comprising:
capturing, by the light sensor, a first pattern of nonvisible light reflected from a plurality of reflective components disposed on a surface of a article;
generating, based on the first pattern of nonvisible light and an article design selected by a user, a first design image; and
projecting, by the image projector, the first design image at the target area containing at least part of the article.

13. The system of claim 12, wherein the instructions that cause the processor to perform operations comprising projecting, by the image projector, of the first design image at the target area containing at least part of the article further cause the processor to perform operations comprising projecting an image of the selected article design onto a surface of the article.

14. The system of claim 12, wherein the instructions that cause the processor to perform operations comprising projecting, by the image projector, of the first design image at the target area containing at least part of the article further cause the processor to perform operations comprising:
projecting an image of the selected article design onto a surface of the article; and
projecting an image of empty space onto surfaces in the target area other those of the article.

15. The system of claim 12, wherein the instructions that cause the processor to perform operations comprising generating, based on the first pattern of nonvisible light and an article design selected by a user, a first design image further cause the processor to perform operations comprising:
generating a three-dimensional model of the article based on the first pattern of nonvisible light and a dimension characteristic of the article; and
generating a two-dimensional image of the selected article design disposed over a surface of the three-dimensional model of the article.

16. The system of claim 12, wherein the instructions further cause the processor to perform operations comprising:
capturing, by the light sensor, a second pattern of nonvisible light reflected from the plurality of reflective components disposed on the surface of the article;
comparing, by the computing device, the first pattern of nonvisible light to the second pattern of nonvisible light;
determining, by the computing device, based on the comparison of the first pattern of nonvisible light to the second pattern of nonvisible light, a plurality of differences between location characteristics of the first pattern of nonvisible light and location characteristics of the second pattern of nonvisible light;
generating, by the computing device, based on the determined plurality of differences in location characteristics and the selected article design, a second design image; and
projecting, by the image projector, the second design image at the target area.

17. An apparatus comprising:
a floor having a target area;
a plurality of nonvisible light sensors, each of the plurality of nonvisible light sensors attached to a respective column of a plurality of columns that extend up at areas of the floor outside of the target area;
a plurality of image projectors, each of the plurality of image projectors disposed outside of the target area and in communication with the plurality of nonvisible light sensors; and
a plurality of mirrors, each of the plurality of mirrors:
attached to a respective support structure of a plurality of support structures that extend up at areas of the floor outside of the target area, and
having a reflective surface that reflects at the target area a beam output from an image projector of the plurality of image projectors.

18. The apparatus of claim 17, wherein the nonvisible light sensors are adapted to capture a first pattern of nonvisible light reflected from a plurality of reflective components disposed on a surface of an article, wherein a computing device is adapted to generate, based on the first pattern of nonvisible light and an article design selected by a user, a first design image, and wherein the image projectors are adapted to project the first design image at a target area containing at least part of the article.

19. The apparatus of claim 18, wherein the computing device is further adapted to generate the first design image by generating a three-dimensional model of the article based on the first pattern of nonvisible light and a dimension characteristic of the article and generating a two-dimensional image of the selected article design disposed over a surface of the three-dimensional model of the article.

20. The apparatus of claim 17, wherein the nonvisible light sensors are further adapted to capture a second pattern of nonvisible light reflected from the plurality of reflective components disposed on the surface of the article, wherein the computing device is further adapted to compare the first pattern of nonvisible light to the second pattern of nonvisible light and based on the comparison of the first pattern of nonvisible light to the second pattern of nonvisible light, a plurality of differences between location characteristics of the first pattern of nonvisible light and location characteristics of the second pattern of nonvisible light, and generate, based on the determined plurality of differences in location characteristics and the selected article design, a second design image, and wherein the image projectors are further adapted to project the second design image at the target area.
